(19) United States
(12) Patent Application Publication
(10) Pub. No.: US 2012/0320909 A1
(43) Pub. Date: Dec. 20, 2012

(54) SENDING REQUEST MESSAGES OVER DESIGNATED COMMUNICATIONS CHANNELS

(76) Inventors: Michael L. Ziegler, Roseville, CA (US); Bruce E. LaVigne, Roseville, CA (US); Jonathan E. Greenlaw, Roseville, CA (US)

(21) Appl. No.: 13/161,945

(22) Filed: Jun. 16, 2011

(51) Int. Cl. H04L 12/50

(52) U.S. Cl. 370/359

(57) ABSTRACT

Techniques described herein provide for sending request messages. The request messages may be sent in order. The request messages may be sent over a designated communications channel.

### BACKGROUND

Data networks are used to allow many types of electronic devices to communicate with each other. Typical devices can include computers, servers, mobile devices, game consoles, home entertainment equipment, and many other types of devices. These types of devices generally communicate by encapsulating data that is to be transmitted from one device to another into data packets. The data packets are then sent from a sending device to a receiving device. In all but the simplest of data networks, devices are generally not directly connected to one another.

Instead, networking devices, such as switches and routers, may directly connect to devices, as well as to other networking devices. A network device may receive a data packet from a device at an interface that may be referred to as a port. The network device may then forward the data packet to another port for output to either the desired destination or to another network device for further forwarding toward the destination. The bandwidth available in a network device for such data transfer may be finite, and as such it would be desirable to make such transfers as efficient as possible.

### BRIEF DESCRIPTION OF THE DRAWINGS

FIG. 1 is a high level block diagram of an example of a network device.

FIG. 2 depicts an example of a stream of ordered data packets.

FIG. 3 depicts an example of message content and structure that may be used in an embodiment.

FIG. 4 depicts an example of data structures that may be used to maintain the status of data packets.

FIG. 5 depicts an example of the life cycle of a single data packet.

FIG. 6 depicts an example of a data structure used to ensure request messages are sent in order.

FIG. 7 depicts an example of data structures used to ensure packets from a stream of ordered data packets are output in order.

FIG. 8 depicts an example of a high level flow diagram for sending a stream of ordered request messages.

FIG. 9 depicts an example of a high level flow diagram for receiving a stream of ordered request messages.

### DETAILED DESCRIPTION

A network device may receive data packets from a plurality of sources and will route those data packets to the desired destination. The network device may receive the data packets through ports that are connected to external packet sources. The network device may then route those data packets to other ports on the network device through a switch fabric. The switch fabric allows for packets to be sent from one port on the network device to a different port. The network device may then output the data packet on a different port.

In many cases, it is desirable that an order between data packets be maintained. For example, a source may be sending a large file to a destination. The file may be broken up into many data packets. The destination may expect those packets to be received in order. Although higher layer protocols exist to address the situation of packets being received out of order, those protocols may require duplicate transmission of data packets once an out of order data packet is received. Such duplicate transmissions would lead to redundant data packet transfers within the switch fabric, which results in a reduction of the efficiency of the network device.

Although it is desirable for data packets to be output in the same order as received, solutions to achieve this result should not lead to additional inefficiency. A switch fabric may be segmented into multiple communications channels, each with a finite bandwidth. A characteristic of a communications channel may be that messages that are input to the channel are output in the same order as they were input. Although restricting transfer of data packets to a single channel would result in the packets being sent in the correct order, such a solution may not utilize the switch fabric bandwidth efficiently. While data packets are being sent over the finite bandwidth of a specific channel, other channels may have available bandwidth. Thus, the available bandwidth may be wasted if the data packets are restricted to a single channel.

The present disclosure includes example embodiments of systems and methods that are used to ensure that data packets are output in the same order in which they are received. Furthermore, the examples of the systems and methods described achieve this result while ensuring that the available bandwidth of the switch fabric may be completely utilized. This beneficial result is achieved through the use of a designated communications channel to convey the desired ordering of data packets, without restricting transfer of the data packets to the designated channel. Each data packet is associated with a request message, and the request messages may be sent in the desired order over the designated communications channel. Because of the characteristics of the communications channel, the request messages will be received in order.

Once the desired order of the data packet has been conveyed, the data packets themselves can then be sent over the switch fabric. There are no restrictions as to the communications channel that may be used to send each data packet or on the order that the data packets are sent and/or received. At the output port, the data packets can be output in the desired order based on the previously received ordered request messages.

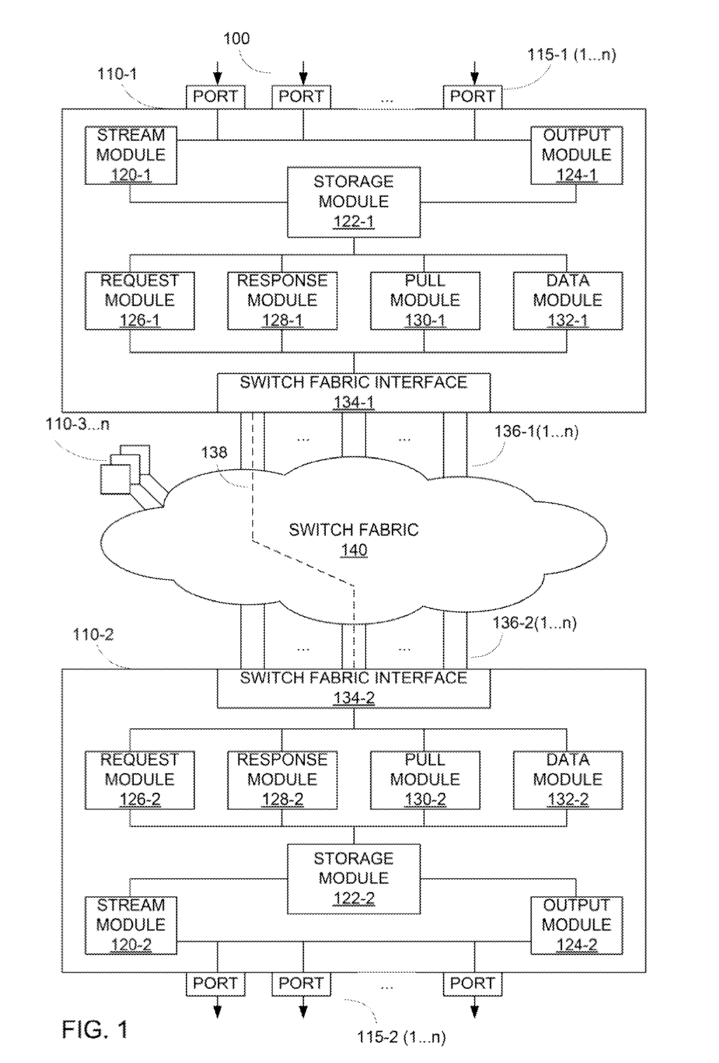

FIG. 1 is a high level block diagram of an example of a network device. The network device 100, such as a switch or router, may implement the example methods and techniques described herein in order to provide for in order output of data packets. The network device may include a plurality of nodes 110-1 . . . n. For purposes of clarity, only two nodes are shown in detail in FIG. 1, however it should be understood that there may be any number of nodes. Furthermore, all nodes are capable of both sending and receiving packets, and may be doing so simultaneously. However, for ease of description, FIG. 1 will be described in terms of a source node 110-1 which will receive data packets from external sources and send them to a destination node 110-2 which will output those data packets to the intended recipients. However, it should be understood that in operation, a node may act as both a source node and a destination node at the same time for different data packets or even for the same packet. In addition, a source node may receive data packets that are intended for multiple destination nodes. For purposes of clarity, only a single destination node is described in FIG. 1.

Source node 110-1 may include a plurality of ports 115-1(1 . . . n). Ports 115-1 may be used to connect to external sources of data packets, such as computers, servers, or even other network devices. The source node 110-1 may receive data packets from these external sources through the ports. The number of ports that exist on a source node may be determined by the design of the network device. For example, in some modular switches, capacity may be added by inserting an additional line card containing 4, 8, 16, or 32 ports. The line card may also contain a node chip to control the data packets sent to and received from the ports. In some cases, depending on the number of ports included on a line card, more than one node chip may be required. However, for purposes of this explanation, a set of ports will be controlled by a single node chip.

The node chip, which will simply be referred to as a node, will typically be implemented in hardware. Due to the processing speed requirements needed in today's networking environment, the node will generally be implemented as an application specific integrated circuit (ASIC). The ASIC may contain memory, general purpose processors, and dedicated control logic. The various modules that will be described below may be implemented using any combination of the memory, processors, and logic as needed.

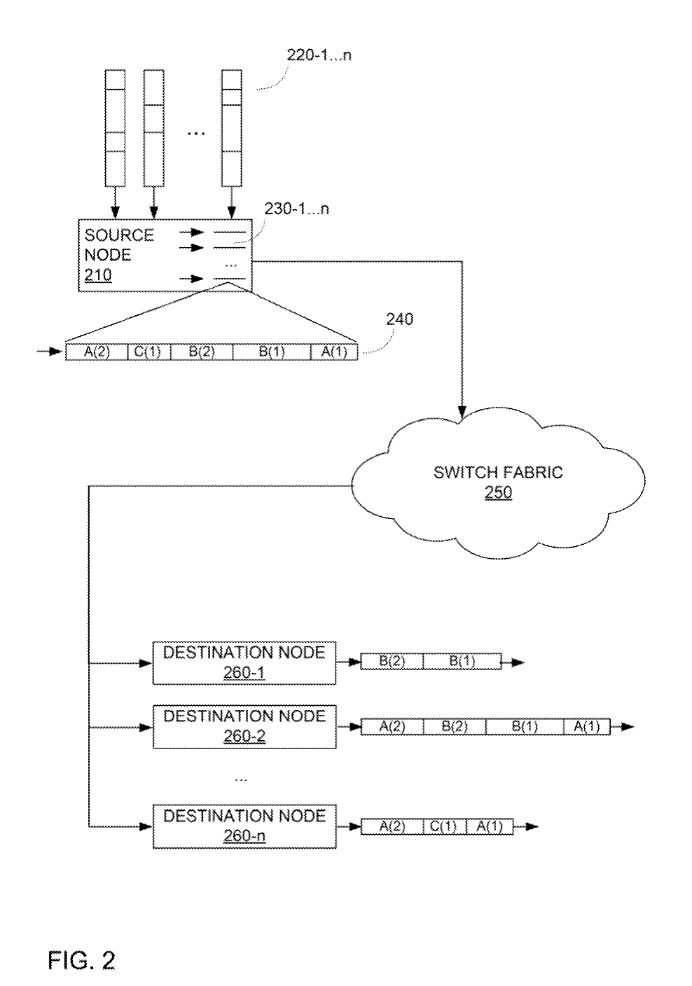

The source node 110-1 may include a stream module 120-1, a storage module 122-1, an output module 124-1, a request module 126-1, a response module 128-1, a pull module 130-1, a data module 132-1, and a switch fabric interface 134-1. The stream module 120-1 may receive all the data packets received from the ports 115-1. The stream module may then classify the data packets into streams. A stream is an ordered set of data packets that will be output in the same order as exists within the stream. Streams will be described in further detail with respect to FIG. 2. As the stream module 120-1 receives data packets from the ports 115-1, the data packets are added to the stream, and stored in storage module 122-1. Storage module 122-1 may be any form of suitable memory, such as static or dynamic random access memory (SRAM/DRAM), FLASH memory, or any other memory that is able to store data packets.

The request module 126-1 may be notified of data packets as they are added to the stream. The request module may determine which node the data packet should be sent to and may generate and send a request message to the determined destination node to inform the destination node that a data packet is available to be retrieved. The request module will issue request messages to the destination node in the same order as the data packets were added to the stream. Thus, the request messages reflect the order in which the data packets were added to the stream. The request module may send the request messages to the determined destination node through a switch fabric interface 134-1.

The switch fabric interface 134-1 is the interface through which a node communicates with the switch fabric 140. The switch fabric interface may contain communications links 136-1 (1 . . . n). Although depicted as separate physical links, it should be understood that there may also only be one physical link to the switch fabric, with multiple logical communications links defined within the single physical interface. The destination node 110-2 also contains a switch fabric interface 134-2 and associated communications links 136-2(1 . . . n). The combination of a communications link on the source node, a path through the switch fabric 140, and a communications link on the destination node may form a communications channel. A characteristic of a communications channel is that messages sent over the channel will be received in the order sent. No such guarantee exists for messages sent using different communications channels, and those messages may be received in any order. A specific communications channel is designated for each stream on the source node 110-1. For example, a designated communications channel 138 may be used for all request messages for the stream that is being described in this example. In cases where there are multiple destination nodes, there may be a designated communications channel for each destination node. Thus, for each stream there is a designated communications channel for each possible destination node. If a request message for a data packet within a stream is to be sent to a destination node, the communications channel designated for that stream and that destination node may be used. In the present example there is a single destination node and the request module will use the designated communications channel 138 to send all request messages for a stream to the destination node 110-2. Because all request messages sent for the stream will use the designated communications channel, it is guaranteed that those request messages will be received in the same order by the destination node 110-2. It should be noted that although there is a designated communications channel for each stream, this does not mean that every stream will use the same communications channel.

The switch fabric 140 is used to connect the nodes 110-1 . . . n. The switch fabric will receive messages from a source node 110-1 through the switch fabric interface 134-1 and will route those messages to a destination node 110-2. The destination node 110-2 will then receive the messages through the switch fabric interface 134-2. The same applies for communication in the reverse direction. The switch fabric may be segmented into multiple communications paths. Each communications path may have a finite bandwidth. Messages sent over a specific communications path will be delivered in the same order that they were sent. As mentioned above, a combination of communications links at the source and destination nodes along with a path through the switch fabric may form a communications channel. Messages sent through the communications channel may be received in the order that they were sent.

The destination node 110-2 has a similar structure to the source node 110-1, however the various modules may provide different processing when acting as a destination node. The request messages may be received, in order, by the request module 126-2. The request module 126-2 may then allocate storage space in the storage module 122-2 for the eventual receipt of the data packet associated with the request message. As the request messages are all sent over the designated communications channel 138, the request messages will be received in the same order as packets were added to the stream. Thus, the destination node is made aware of the ordering of the data packets in the stream.

The destination node 110-2 may then use the response module 128-2 to send a response message to the source node. The response message may be sent over any communications channel. There is no requirement to use the designated communications channel 138. The response messages therefore may be received in any order by the source node 110-1. The response module 128-1 on the source node may then receive the response message. The response message may contain additional data and the use of that data will be described in further detail below.

The destination node 110-2 may then use the pull module 130-2 to send a pull message to the source node 110-1. The pull message may be sent over any communications link 136-2. The pull message is used to notify the source node 110-1 that the data packet is now being requested by the destination node 110-2. The source node may receive the pull message in the pull module 130-1. The pull module 130-1 may then notify the data module 132-1 that the data packet should be sent to the destination node 110-2. The data module may then retrieve the data packet form the storage module 122-1 and send the data packet to the destination node 110-1 in a data message. The data message may be sent over any communications link 136-1.

The destination node 110-2 may then receive the data message in the data module 132-2. The data module 132-2 may store the data packet received in the data message in the previously allocated storage space in the storage module 122-2.

As mentioned above, request messages are sent over a designated communications channel 138, thus guaranteeing that the request messages will be received by the destination node 110-2 in order. Thus, the order of the data packets is conveyed to the destination node through the request messages alone. However, all other messages may be sent over any communications channel. Thus there is no guarantee that messages other than request messages will be received in order. For example, a data packet that is later in the stream of data packets may be received by the destination node prior to one that is earlier in the stream. The output module 124-2 may maintain the expected order of data packets based on the request messages. The output module 124-2 may output the data packets to a port 115-2 (1 . . . n) of the destination node 110-2 in the same order as the stream, based on the order of the request messages.

Data packets within a stream may thus be output from a port on the destination node in the same order as the stream, while only requiring that request messages be sent in order. Because ordering of the data packets is maintained through the request messages only, there is no requirement that the data packets be sent in any order or over a specific communications channel. As a communications channel typically has a finite bandwidth, the ability to use any available communications channel to send data packets increases efficiency, as there is no need to wait for a specific communications channel to become available. Furthermore, because any communications channel may be used to send data packets, efficiency through the switch fabric may be increased because multiple data packets may be transmitted through the switch fabric simultaneously over different communications channels.

FIG. 2 depicts an example of a stream of ordered data packets. A plurality of data packets may be received by a source node 210. For example, the packets may be received on the ports 220-1 . . . nof the source node. The received packets may come from end user computers, servers, or from other networking devices. These packets may all be received by the source node.

The source node 210 may classify these incoming packets into various streams 230-1 . . . n. The number of possible streams may be preset or may be configurable by a user. The source node, using a stream module (not shown) may classify the incoming packets into streams. Packets may be classified into streams based on many criteria. For example, all packets destined for a specific destination node may be classified into a stream. Packets with certain guaranteed quality of service (QoS) parameters may be classified into a stream. Packets originating from the same source may be classified into a stream. Combinations of criteria may be used as well, such as packets of a particular QoS, originating from the same source, and all destined for the same destination node may be classified into a stream. Example implementations discussed herein are not dependent on the exact criteria used to classify packets into streams.

However, once classified into a stream, the stream has certain characteristics. One characteristic of the stream is that it is an ordered list of data packets. As new packets are added to the stream, they are added to the end of the stream. Another characteristic of the stream is that data packets in the stream should be output from a port on a destination node in the same order as they appear in the stream. Note, this does not imply that the data packets are sent to the destination node in order or that every packet within a stream will be sent to the destination node for output on a port. Rather, the characteristic of a stream is that all packets destined for output on a port of a destination node will be output from that port in the same order as the packets in the stream.

The stream 240 is an expanded example of one of the streams 230-1 . . . n. As shown, there are currently five packets within the stream. The letter indications of the packets may indicate a certain criteria. For example, the letter criteria may indicate the source of the data packet. For purposes of this description, the letters are simply used to differentiate packets in terms of whether a destination node will receive a packet for output on a port. For example, if a destination node is to output one packet marked ‘A’ on a port, it will receive all packets marked A. Similarly, packets are marked with a number within their letter designation to represent the order of the data packets. For example, packet A1 is before packet A2.

The packets within a stream may be sent over a switch fabric 250 to a destination node. There is no requirement as to the order the packets are sent over the switch fabric, however, when the packets are output from a port of the destination node, the packets should be in the same relative order as they were in the stream.

Destination node 260-1 is an example of a destination node. In this example, destination node 260-1 is designated to receive data packets designated as ‘B’ and output those packets on a given port. Thus, the packets marked ‘A’ and ‘C’ will not be sent to destination 260-1. However, the packets that are sent to destination node 260-1 will be output from the given port in the same order as they exist in the stream 240. As shown, the packets are output by the given port of destination node 260-1 include those packets marked ‘B’ in the same order as they appeared in the stream 240. In particular packet B(1) is output before B(2) because that is the order of the packets in the stream 240. It should be understood that the destination nodes 260-1 . . . n may include other ports (not shown) and that the ordered output of data packets is on a per port basis. Furthermore, it should be understood that data packets from other streams may also be output on the port. In other words, packet B(1) may be output on the port before packet B(2), however packets from other streams may be output between packets B(1) and B(2).

Destination node 260-2 is an example of a destination node that is designated to receive packets designated as ‘A’ or ‘B’ and as such, no packets marked will be sent to destination node 260-2. Again, the packets are output from a port on the destination node 260-2 in the same order as they appeared in the stream 240. In this case, the output order is A(1), B(1), B(2), and A(2), because this is the order of the packets in the stream 240. Destination node 260-n is yet another example of a destination node that is designated to receive a different set of data packets. In this case, destination node 260-n is designated to receive data packets from the stream marked ‘A’ or ‘C’ and not those marked ‘B’. Again, the data packets will be output on a port in the same order as they exist in the stream 240.

As mentioned previously, there is no ordering requirement as to how the data packets are sent over the switch fabric. Data packets may be sent or received in any order. For example, data packet B(2) may be the first data packet that is sent over the switch fabric and received by a destination node. However, data packet B(2) will not be output from the port on the destination node until all prior packets in the stream destined for the port have been output. Thus, data packet B(2) will not be output on a port before data packet B(1) is output. Maintaining the proper ordering of the output of the data packets is left to the ordering of the request messages and associated data structures, which are described in further detail below.

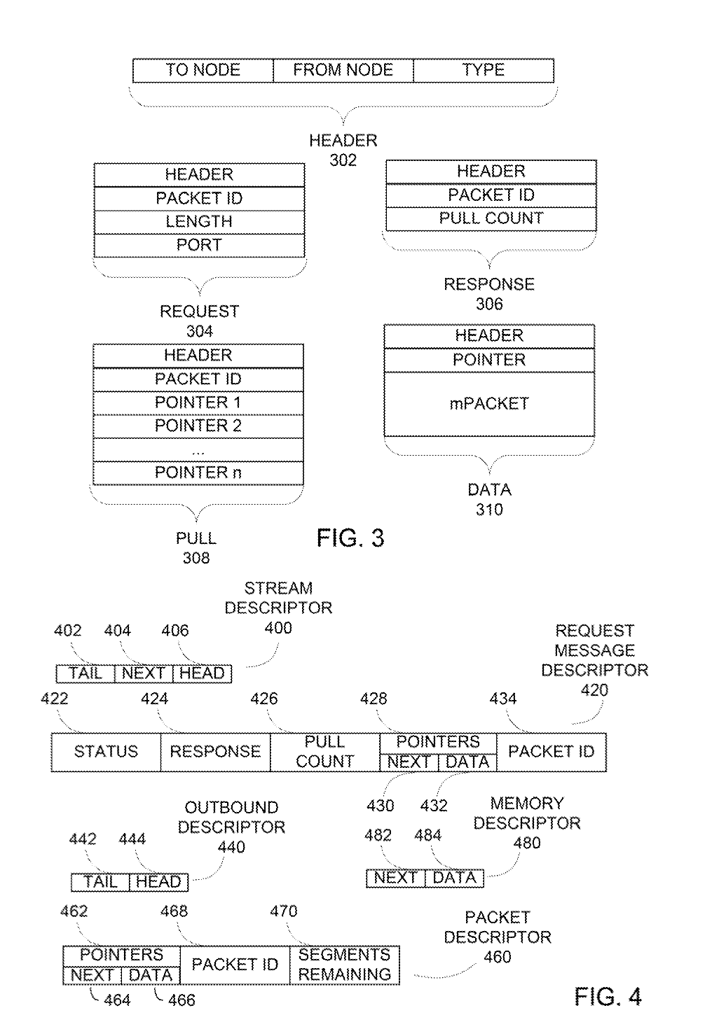

FIG. 3 depicts an example of message content and structure that may be used in an embodiment. The messages described in FIG. 3 are an example of those that may be used with the system as described in FIG. 1. In this example implementation, each message includes a header 302. The header may include a ‘To Node’ field which identifies the node that the message is intended for. Also included is a ‘From Node’ field which identifies the node that sent the message. The node identifications may used by the switching fabric to properly transfer messages from the sending node to the intended recipient node. In addition, the header may also include a ‘Type’ field which is further used to identify the contents and structure of the message when received.

In the present example implementation there are four basic message types as well as one hybrid message type (not shown). Each message type includes the header 302 which will not be described further. The first message type is the request message 304. The request message may be used by a source node to notify a destination node that a data packet is available for delivery. The request message includes a ‘Packet ID’ field. The ‘Packet ID’ field may be used to identify a particular stream as well as an individual data packet within that stream. For example, a first portion of the ‘Packet ID’ may identify the individual stream within the source node that is the origin of the data packet, while a second portion may identify an individual data packet within that stream. In an alternate example implementation, the ‘Packet ID’ may indicate the location in memory where information related to the packet is stored. The ‘Packet ID’ field may be used by the source and destination node to identify the data packet that is referred to in the request message.

The request message may also include a ‘Length’ field which specifies the length of the data packet. The ‘Length’ field may be used by the destination node to determine how much memory space should be allocated for the data packet in order to ensure the availability of memory to store the data packet when it is received. In some cases, it may be necessary to segment a data packet into smaller packets, which may be referred to as mPackets, in order to send the data packet from the source node to the destination node. The ‘Length’ field may be used by the destination node to determine how many mPackets will be needed to transport the data packet from the source to the destination node.

Also included in the request message may be a ‘Port’ field. The port field may be used to indicate on which ports of the destination node the data packet should be output. In many cases, the data packet may only be destined for output on a single port a destination node and this port will be indicated in the ‘Port’ field. In other cases, the data packet may be destined for multiple ports on a destination node, and each of those ports will be indicated in the ‘Port’ field.

The next message type is the response message 306. The response message may be used by a destination node to notify the source node that a request message has been received. The response message may include a ‘Packet ID’ field that identifies the data packet as described with respect to the request message. When the source node receives the response message, the ‘Packet ID’ field may be used to match the response message with the originally sent request message. For example, the request message may be marked as having been acknowledged once a response message containing a matching ‘Packet ID’ field has been received.

The response message may also include a ‘Pull Count’ field. The ‘Pull Count’ field may be used by the destination node to notify the source node as to how many times the data packet will be pulled (i.e. retrieved) from the source node. In some cases, a request message may be sent for a data packet, but the destination node has no need for the data packet. For example, the computer for which the data packet is destined may no longer be available and as such there would be no reason for the source node to send the data packet as it will never reach its intended destination.

In other cases, the destination node may wish to pull the data packet more than once. For example, the packet may be destined for multiple output ports on the destination node. The destination node may pull the data packet for each port individually. The destination node may also choose to pull the data packet a single time, as only one output port may need the data packet, or the destination node chooses to locally copy the data packet to all output ports that need the data packet. The ‘Pull Count’ field may be used to notify the source node of how many data packet retrievals to expect. In an alternate implementation, the ‘Pull Count’ field may simply be a true/false indicator. A true value may indicate the destination node's intention to pull the packet a single time, while a false value indicates the data packet will not be pulled.

The next message type is the pull message 308. The pull message may be used by the destination node to initiate retrieval of the data packet from the source node. The pull message may include a ‘Packet ID’ field which is used to identify the data packet that is being retrieved. The pull message may also include ‘Pointer’ fields. The ‘Pointer’ fields are used by the destination node to notify the source node of the location in memory on the destination node where the data packet will be stored. As mentioned above with respect to the request message, the destination node allocates memory space for the data packet based on the ‘Length’ field. The pointer field contains the memory addresses or references to the memory addresses of the allocated storage space.

If only one allocation of memory is needed, for example if the data packet will not be segmented into multiple mPackets, there will only be a need for a single ‘Pointer’ field. However, if the data packet will be segmented into multiple mPackets, a pointer will be provided for the memory space allocated for each mPacket. It should be understood that there is no requirement for memory space to be allocated sequentially and that the pointers may point to any available memory locations once allocated.

Although there is no requirement that memory space be allocated sequentially, in some implementations using partial sequential allocation may allow for more efficient transfer of the pointers from the destination node to the source node. For example, mPackets may have a fixed maximum size and memory may be allocated in units of that fixed size. Both the source and destination node have the length of the data packet and are able to determine how many mPackets will be required to transfer the data packet. A convention may be established that memory will always be allocated in a fixed number of consecutive blocks. Based on this convention, the source node may be able to calculate the actual pointers for each mPacket without having to receive each pointer explicitly.

As a simple example, a data packet may require segmentation into eight mPackets. A convention may exist that memory will always be allocated in units of four blocks. The destination node may receive the request message, and allocate two units of storage with four mPackets consecutively stored within each block. The destination node may then return pointers to the start of each of the two units two of consecutive blocks in the pull message. The source node would then retrieve the first pointer from the pull message and would know the address of the first mPacket. The source could then add the size of an mPacket to this pointer to compute the address of the second mPacket, add the size of two mPackets to compute the address of the third mPacket, and add the size of three mPackets to compute the address of the fourth mPacket. The same process could be used with the second pointer. Thus, eight pointers were effectively communicated, while only requiring two pointers actually be sent.

In yet another example implementation, a destination node may maintain a table whose entries in turn point to locations in memory. The destination node may then include the address of a table entry in the pointer field. The source node may then use the address of the table entry and the destination node will use the table to look up the actual address in memory. Similarly to above, a convention may be established that table entries will be allocated in units. For example, a unit of four consecutive table entries may be allocated. A pointer to the first allocated table entry may be provided to the source node. The source node may then determine the actual table entry based on an offset from the pointer. For example, for the first mPacket, the table entry would be specified by the pointer itself, whereas the third mPacket would be specified by the pointer plus an offset of two table entries. As the table entries contain the actual addresses in memory of the allocated storage space, there is no need for memory to be sequentially allocated.

The last basic message is the data message 310. The data message is sent from the source node to the destination node to transfer at least part of the data packet from the source to the destination node. The data message may include a ‘mPacket’ field which is used to contain at least a portion of the actual data of the data packet that is being transferred.

The data message may also include a ‘Pointer’ field that is the same as the ‘Pointer’ field that was designated for a particular mPacket in the pull message. Including the pointer for the allocated storage space along with the data that will actually populate that space may allow for simplified and more efficient processing on the destination node. For example, upon receipt of the data message, the destination node may simply extract the ‘Pointer’ field and store the data contained in the ‘mPacket’ field starting at the address specified by the pointer or by the address specified in the table entry pointed to by the pointer. The destination node does not need to perform any processing to determine which mPacket was received and the specific storage space that was allocated for that mPacket because that information was included along with the data itself. Furthermore, the pointer may be used to allow the destination node to determine when all the mPackets that make up a data packet have been received, as will be described below.

The final message type is a hybrid message type called a response-pull message (not shown). In structure, the response-pull message type may be the same as the pull message 308. In operation, a source node receiving a response-pull message will behave as if it had received two messages. First, the source node will treat the response-pull message as a response message which indicates that the data packet will only be pulled a single time. Second, the source node will treat the response-pull message as a pull message to pull the data packet. In some cases, the information contained in the response and pull messages may be small enough that the contents of both may fit into a minimally sized message. For example, for small data packets, only a small number of pointers may be required. The pointers and all the other information in the response and pull messages may fit into a message that is small enough to be efficiently transferred. Combining these two messages into a single message may reduce the total number of messages that need to be sent between the source and destination nodes, thus reducing the amount of switch fabric bandwidth used for control overhead, and increasing the bandwidth available for actual data packet transfer.

Although the above description introduced the concept of segmentation of a data packet into multiple mPackets, it should be understood that such segmentation is a matter of implementation and is optional. For example, the mPacket size could be specified such that it is larger than any data packet that could be received by the source node. Thus, no segmentation would ever be necessary, as the data packet would always be able to fit within a single mPacket. The net result being that the mPacket would be the effective equivalent of the data packet itself.

FIG. 4 depicts an example of data structures that may be used to maintain the status of data packets. A stream descriptor 400 in combination with request message descriptors 420 may be an example of a source node data structure that is used to indicate the status of each data packet in the stream of ordered data packets. The status may be maintained at least until the data packet is successfully sent to the destination node. A stream descriptor may exist for each stream of ordered data packets on a source node. The stream descriptor may generally be a handle for a list, such as a linked list, of request message descriptors. Each request message descriptor may be associated with a data packet in the stream.

The stream descriptor 400 may contain several data fields. The tail field 402 may be a pointer that points to the last request message descriptor in the list of request message descriptors. Likewise, the head field 406 may be a pointer that points to the first request message descriptor in the list of request message descriptors. The stream descriptor may also contain a next field 404 which is a pointer to the request message descriptor that will be the next request message to be sent to the destination nodes.

The request message descriptor 420 may also contain several data fields. The status field 422 may indicate the current status of the request message. In one example implementation, the request message has one of four different statuses. The first status may be pending, wherein a data packet has been added to the stream and the associated request message descriptor is still in the process of being added to the stream descriptor. A request message descriptor in pending status is not eligible to have a request message sent from the source node to the destination nodes. The second status may be ready. A request message descriptor in the ready status has been added to the stream descriptor, but is not yet eligible for a request message to be sent from the source node to the destination nodes. For example, some additional processing may be occurring on the data packet which may require that no request message be sent.

The next status may be active. In the active status, any additional processing of the data packet is complete and a request message may be sent from the source node to the destination nodes once this request message descriptor becomes the next eligible descriptor. For example, once the next pointer 404 is set to point to a request message descriptor that is in the active state, a request message may be sent from the source node to the destination nodes.

The final status is inactive. In the inactive status, the request message descriptor is no longer needed. The data packet associated with the request message descriptor has already been sent to the destination nodes for a request message descriptor with an inactive state. The request message descriptor with inactive status is eligible for removal from the stream descriptor. For example, when the head pointer 406 is set to point to an inactive request message descriptor, the request message descriptor may be removed and the head pointer set to point to the next request message descriptor in the list.

The request message descriptor 420 may also include a response field 424. The response field may be used to indicate if a request message for the data packet associated with the request message descriptor has been sent and may also be used to determine if a response to that request message has been received. For example, when a request message is sent, the response field may be incremented to indicate that a request message has been sent. When the response to the request message is received, the response field may be decremented to indicate that the response has been received. For example, if the request message is sent to multiple destinations, the response field may equal the number of destinations to which the request message was sent. As responses are received from the destinations, the response field is decremented. Responses from all destinations may have been received once the response field indicates a value of zero.

The request message descriptor may also include a pull count field 426. As mentioned above, a destination node will respond to a request message with a ‘Pull Count’ that indicates how many times the destination node will be pulling a data packet. The ‘Pull Count’ value may store the pull count received from each destination node. For example, if a request message is sent to two destination nodes, and each node indicates that data will be pulled once, the pull count field may store a value of two. Each time a destination node pulls the data, the pull count field may be decremented. Once the values of the pull count and response fields reach zero, the source node is made aware that no further data pulls should be expected for this packet. The combination of the response field and the pull count field may be used at the source node to determine when a request message descriptor will be transitioned into the inactive state, which will be explained in further detail below.

The request message descriptor 420 may also include various pointers. Some pointers that may be included are a next pointer 430 and a data pointer 432. As mentioned above, in one example implementation, the stream descriptor points to a linked list of request message descriptors. The next pointer may be used to indicate the next request message descriptor in the linked list. The data pointer 432 may point to the data packet that is associated with the request message descriptor. When a new data packet is received, memory space is allocated for the data packet and the data packet is added to a stream. The data pointer 432 may point to the location in memory that was allocated for the data packet.

The request message descriptor 420 may also include a packet id field 434. As has been mentioned above, a packet id field is used to identify an individual data packet and stream. In one example implementation, the packet id may be stored as a field in the request message descriptor. In an alternate example implementation, the address of the memory space allocated for a request message descriptor may be the packet id. Thus, instead of storing the packet id in a field of the request message descriptor, the packet id may directly refer to the address in memory of the request message descriptor. Regardless of any particular implementation, the packet id field may be used to correlate various request and response messages such that the appropriate request message descriptor is identified based on the packet id field contained in the messages described above.

An outbound descriptor 440 in combination with packet descriptors 460 may be an example of a destination node data structure that is used to indicate the status of each data packet for which a request message has been received. The status may be maintained at least until the data packet is placed in an output queue for delivery. An outbound descriptor may exist for each stream of ordered data packets from which the destination node may receive request messages. The outbound descriptor may generally be a handle for a list, such as a linked list, of packet descriptors. Each packet descriptor may be associated with a data packet in a stream.

The outbound descriptor 440 as shown may include a tail pointer 442. The tail pointer may point to the last packet descriptor in the list of packet descriptors. The outbound descriptor may also include a head pointer 444 which points to the first packet descriptor in the list of packet descriptors. A packet descriptor 460 may include several fields including a pointers field 462. The pointers field may include a next pointer 464 which may be used to point to the next packet descriptor in the list of packet descriptors. The pointers field may also include a data pointer 466 which points, either directly or indirectly, to memory space that is allocated for receiving the data packet that is associated with the packet descriptor. The packet descriptor may also contain a packet id field 468 which identifies the data packet, as has been discussed above. In one example implementation, a segments remaining field 470 may be included to allow the destination node to determine when the complete data packet has been received. In an alternate example implementation, the segments remaining field may not be contained within the packet descriptor, but rather may be stored elsewhere. As described above, in some example implementations, a table is provided, and the entries in the table identify locations in memory where received data packets will be stored. The table may contain the segments remaining field. In a slightly different example implementation, the table may store a pointer to the packet descriptor or the segments remaining field of the packet descriptor. The operation of the data pointer and the segments remaining field will be described in further detail below.

When a request message arrives from a source node, the destination node may allocate a packet descriptor 460 to maintain the status of the data packet identified in the request message. The destination node may add the packet descriptor to the end of the outbound descriptor 440 by resetting the tail pointer 442 to point to the newly allocated packet descriptor and then adjusting the next pointer 464 of the packet descriptor that was previously pointed to by the tail pointer. As was mentioned above, request messages are always sent in the same order as their associated data packets appear in a stream over a designated communications channel. Because the order of the request messages is maintained through the designated communications channel, the request messages will be received in the same order as the associated data packets.

Thus, the outbound descriptor maintains a list of ordered packet descriptors which are each associated with a data packet and the ordering is the same as the ordering of the data packets in the stream of data packets. Proper ordering of the data packets in a stream can be conveyed to the destination node through the request messages independently, without having to send the data packets themselves in order.

When a new request message is received, the destination node may also allocate memory space to store the data packet that is associated with the request message. In one example implementation, the destination node may allocate a single, contiguous block of memory to store the data packet, and the data pointer 466 may be set to point to the allocated memory. In a different example implementation, the destination node may allocate memory in smaller blocks, such as blocks that are the size of an mPacket. For each block, a memory descriptor 480 may be allocated. The memory descriptor may contain two fields, a next pointer 482 which points to the next memory descriptor and a data pointer 484, which points to the actual space in memory allocated for the block.

When a request message is received, and it is determined that the data packet will be segmented, the destination node calculates the number of mPacket size data blocks that will be needed to store the data packet. For each data block, a memory descriptor may be allocated and formed into a linked list using the next pointers 482. The data pointers 484 of each memory descriptor may then be set to point to the allocated memory space. Finally, the data pointer 466 of the packet descriptor 460 may be set to point to the head of the list of memory descriptors.

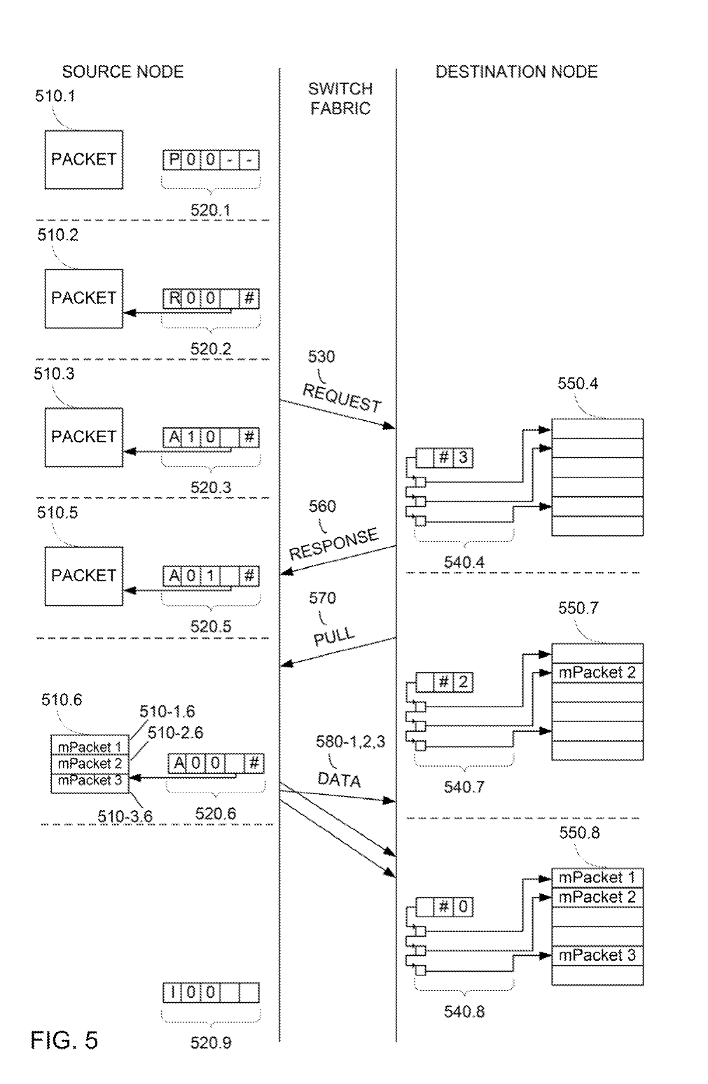

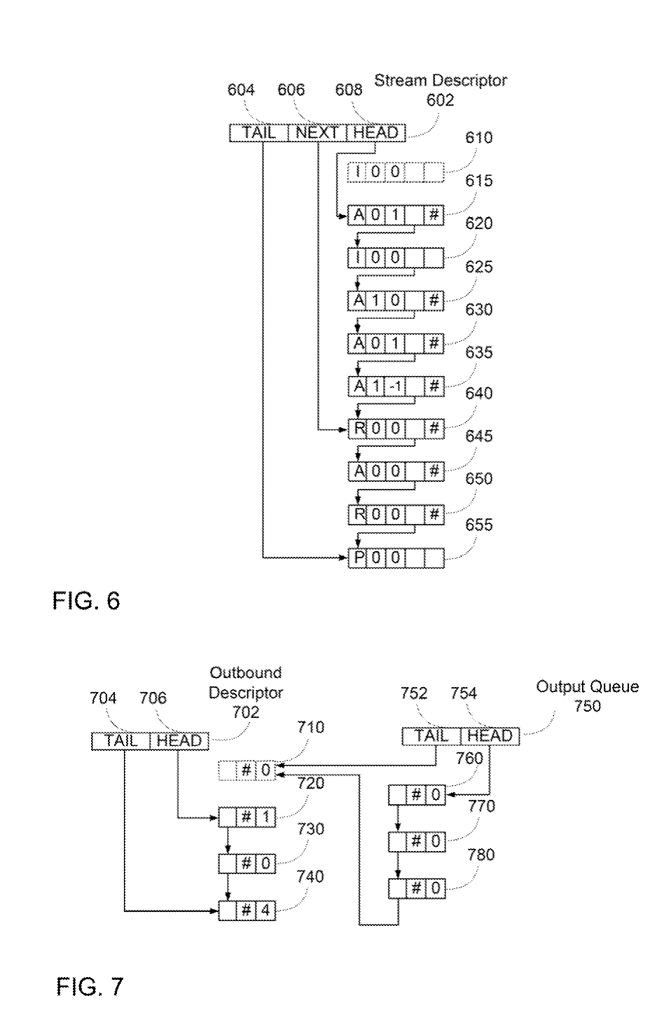

The number of calculated mPackets needed to store the data packet may also be stored in the segments remaining field 470. In an alternate example implementation, the number of calculated mPackets may be stored in the table used to associate pointers with actual memory addresses. The segments remaining field may be used by the destination node to determine when the complete data packet has been received. Upon receipt of each data message containing an mPacket, the segments remaining field for the associated packet will be decremented. Once the count reaches zero, no more data messages are expected, as all of the mPackets have now been received. The data packet has then been received completely by the destination node. The operation of the data messages and data structures described in FIGS. 3 and 4 will be described in further detail with respect to FIGS. 5 and 6.

There is an additional data structure, an output queue (not shown), that may be utilized by a destination node. The output queue has essentially the same structure as the outbound descriptor 440 and packet descriptors 460. The difference being that the outbound descriptor is used to maintain the status of data packets at a destination node as they are received from the source node, whereas the outbound queue is used to maintain the status of the data packets as they await transmission via a port of the destination node.

FIG. 5 depicts an example of the life cycle of a single data packet. For purposes of this example, the data packet has already been received at a port of a source node, classified into a stream, and has been stored in the storage module. In FIG. 5, several elements are repeated in order to show the evolution of the element over time. The elements are repeated with the same base number with different decimal numbers to indicate the progression of time. For example, an element xxx.1 may contain a certain data value. References to element xxx.2 are to the same element, but at a later point in time. For simplicity of explanation FIG. 5 is described in terms of a data packet that is sent to a single destination node, however it should be understood that the data packet may be sent to multiple destinations.

As mentioned above, a data packet 510.1 may have been received and classified into a stream at a source node. A request message descriptor 520.1 may be allocated for the data packet at the source node. The request message descriptor may have its status set as pending, as indicated by the letter P, while the request message descriptor is integrated within the stream descriptor. At some point in time, the request message descriptor 520.2 may be integrated within the stream descriptor. The request message descriptor 520.2 may set a pointer to the data packet 510.2. The request message descriptor may then move into the ready state as indicated by the letter R. In the ready state, additional processing may occur on the request message descriptor or on the data packet. At this point, the data packet 520.2 is not yet eligible to have a request message issued.

At some point, the request message descriptor 520.3 may transition to the active state, as indicated by the letter A. Once in the active state, the data packet 510.3 is eligible to have a request message issued. However, the request message will not issue until the next pointer of the stream descriptor is set to point to request message descriptor 520.3. Once the next pointer does point to request message descriptor 520.3, a request message 530 may be sent from the source node to the destination node across a designated channel of the switch fabric. The source node may increment the response field of the request message descriptor 520.3 to indicate that a request message has been sent for the data packet. For example, a value of one may be stored in the response field if the request message is sent to a single destination. The source node may also determine the ports on the destination node on which the data packet should be output. This port information is included in the request message.

Upon receipt of the request message 530 by the destination node, the destination node may allocate a packet descriptor 540.4 to maintain the status of the received request message. The destination node may store the packet id that was received in the request message in the packet descriptor 540.4. In addition, the destination node may determine if the data packet will be segmented based on the length of the data packet as communicated in the request message. As shown, the data packet will be segmented into three segments. The destination node may then allocate storage space within memory 550.4 to store the received segments. The packet descriptor 540.4 may store pointers to the allocated memory space in a list. The destination node may then send a response message 560 to the source node. Included in the response message may be an indication of the number of times the destination node will pull the data as well as the packet id.

Upon receipt of the response message, the source node may examine the response to determine the packet id contained therein. The packet id may be used to locate the request message descriptor 520.5. The source node may then decrement the response field of the request message descriptor 520.5 to indicate that a response has been received. For example, the response field may be set to a value of zero if only one request message was sent to a single destination. The source node may also store the indication of the number of times the data will be pulled in the pull count field of the request message descriptor 520.5. In the case of multiple destinations, the source node may store the sum of the pull count fields from all received response messages. The source node may then wait for a pull message from the destination node, which will begin the actual transfer of the data packet.

The destination node may then send a pull message 570 to the source node. Included in the pull message may be the pointers to the memory that was previously allocated as well as the packet id of the data packet that is being pulled. In an alternate example implementation, the pointers may point to entries in a table, which in turn point to the allocated memory. The source node may receive the pull message 570. The source node may segment the data packet 510.6 into the required number of segments, also called mPackets. For example, in this case, the data packet 510.6 is segmented into three mPackets 510-1.6, 510-2.6, 510-3.6. The source node may then send the mPackets to the destination node in three data messages 580-1,2,3. Included in the data messages may be the pointer to memory space or table entries allocated on the destination node

There is no requirement that the data messages be sent in any order, nor is there any requirement that the data messages be received in any order. The system is able to process the data messages regardless of the order in which they are received. As shown, the data message associated with the second mPacket may actually be the first to arrive at the destination node. The pointer included in the data message is used to identify the location of the segments remaining field, which may be in the table of memory addresses or in the packet descriptor. The destination node may then decrement the segments remaining count of the packet descriptor 540.7 or the table, depending on the implementation, to indicate that a segment has been received. The received mPacket may be stored in the memory 550.7. It should be noted that the destination node is beneficially relieved of having to keep track of which segment has been received, and need only be aware that some segment was received. The destination node does not need to perform any complex correlation of segment to allocated space, because the information necessary to identify the allocated space is included with the data message.

At some point, the remaining data messages containing the remaining segments are received at the destination node. The destination node may store the received segments in the memory space 550.8 identified by the pointer included in the data messages. Once the segments remaining count has reached zero, the data packet 510 has been completely transferred from the source node to the destination node. The request message descriptor 520.9 may be transitioned to the inactive state once no additional messages are expected and all data message have been sent. In other words, once responses are received for all request messages sent for the data packet, the expected number of pulls, as specified in the response messages have been received, and the data messages sent, the request message descriptor may transition to the inactive state because no further action is necessary for the data packet. Although shown as the last transition to occur in FIG. 5, it should be understood that the transition to inactive may occur at any time after all actions for the request message descriptor are completed. As depicted in FIG. 5, the transition to inactive could have occurred immediately after data message 580-3 was sent. The request message descriptor may then be released and is available for the next data packet to arrive.

FIG. 6 depicts an example of a data structure used to ensure request messages are sent in order. The data structure 600 depicted in FIG. 6 is an example of a snapshot of a data structure based on the source node data structures that were described in FIG. 4, in operation. The stream descriptor 602 is associated with a stream of data packets on a source node. Each data packet in the stream is associated with a request message descriptor 610, 615 . . . 655. The tail pointer 604 of the stream descriptor is set to point to the request message descriptor that is associated with the last data packet in the stream, while the head pointer 608 is set to point to the request message descriptor that is associated with the data packet that is at the head of the stream. The next pointer 606 is set to point to the request message descriptor for the next data packet that will have a request message sent to the destination node. For purposes of clarity, the data pointers 432 of the request message descriptors have been omitted, however it should be understood that each request message descriptor includes a pointer to memory space that stores a data packet.

A request message descriptor 655 may represent a data packet that has just been added to the stream. The request message descriptor 655 is shown in the pending state, as indicated by a status of P, meaning that it is still in the process of being added to the list of request message descriptors, and is not yet eligible for a request message to be issued. Request message descriptor 650 may represent a data packet that is in the ready state, as indicated by the status of R. The request message descriptor 650 may have been added to the list of request message descriptors, however additional processing may still be occurring, thus no request message may be sent. As shown, a packet id which identifies the data packet has been included in the request message descriptor.

The request message descriptor 645 represents a data packet that is now in the active status. An active request message descriptor is eligible to have a request message sent to the destination node, once the next pointer 606 is set to point to the active request message descriptor. As shown, the response and pull count fields of request message descriptor 645 are set to null, as no request message has been sent yet.

The request message descriptor 640 represents a data packet that is still in the ready state, similar to the request message descriptor 650. What should be understood is that the status of each individual request message descriptor is independent of the other descriptors. It does not matter that subsequent request message descriptor 645 is in the active state, as the status of the request message descriptors is not dependent on previous or subsequent request message descriptors. Furthermore, the next pointer 606 is currently set to point to request message descriptor 640. Once the request message descriptor 640 transitions to the active state, a request message will be sent for it to the destination node, and the next pointer will be advanced. Because the request message descriptor 645 is already in the active state, a request message may also be sent for that data packet, and the next pointer will again be advanced.

The request message descriptor 635 represents a data packet for which a request message has already been sent, as the next pointer has proceeded beyond this descriptor. The response field has been set to one to indicate that a request message has been sent, but that no response has been received yet. Furthermore, the pull count has been set to negative one, indicating that a pull message has been received. As mentioned previously, there is no ordering requirement within the system, aside from ordered issue of request messages. Thus, it is entirely possible that a pull message may be received before a response message which indicates how many times the data will be pulled, resulting in the pull count becoming a negative number. When the response message is eventually received, the pull count contained therein will be added to the pull count field of the request message descriptor. Once that count reaches zero, assuming all response messages have already been received, it can be determined that no additional pull messages are expected.

The request message descriptor 630 represents a data packet for which a request message has been issued and a response message received, as indicated by the zero in the response field. The response message may have indicated that the data will be pulled one time, as is reflected in the pull count field. When a pull message is eventually received for this data packet, the pull count will be decremented. Once the pull count reaches zero, assuming that the request message was sent to only a single destination node, no additional pull messages are expected.

The request message descriptor 625 represents a data packet for which a request message has been sent to a single destination, but no response or pull messages have been received, as indicated by a one in the response field and a zero in the pull count field. Once a response message is received, the response field will be set to zero to indicate the receipt of the response and the pull count will be set to indicate the number of pulls that are expected. The pull messages, when received, will decrement the pull count field. Again, there is no order imposed on receipt of response and pull messages.

Request message descriptor 620 represents a data packet for which a request has been sent, the response received, and all expected pull messages have been received, as indicated by the response and pull count fields being set to zero. At this point, no additional processing is needed for the associated data packet, as it has already been sent to the destination node. The request message descriptor is thus transitioned to the inactive state, and is eligible for removal once the head pointer reaches this particular request message descriptor.

The request message descriptor 615 represents a data packet for which a request has been issued and response indicating a single pull has been received. Once the pull message for this request message descriptor is received, the descriptor may transition into the inactive state. Once the transition to the inactive state has occurred, the request message descriptor may be removed from the list, as the head pointer 608 currently points to this request message descriptor. The head pointer will then be advanced to the next request message descriptor in the list.

The request message descriptor 610 represents a data packet that is now in the inactive state and has been removed from the list. The request message descriptor is now unused and is available for allocation for the next data packet that is added to the stream.

In operation, as data packets are added to the stream, a new request message descriptor is added to the end of the stream described by stream descriptor 602. The next pointer 606 advances through the ordered list and issues a request message to the destination node if the request message descriptor indicates an active status. If the status of the request message descriptor is not active, the next pointer remains pointing at the descriptor until the status transitions to active, at which point the process continues. It should be understood that the result of this process is that request messages are issued for data packets in the same order as the data packets exist in the stream. Because request messages are sent over a designated channel, it is guaranteed that the order will be preserved over the switch fabric and the request messages will be received in order by the destination node.

Once the request message for a data packet has been sent, processing proceeds as has been described with respect to FIG. 5. Once processing on the data packet is complete, the request message descriptor is marked as inactive. The head pointer advances through the list of request message descriptors and releases descriptors that are inactive. If the head pointer reaches a request message descriptor that is not inactive, the head pointer does not release the descriptor and waits until the descriptor becomes inactive. Once a descriptor is released, it again becomes available for allocation when a new data packet is added to the stream.

FIG. 6 has generally been described in terms of a source node sending data packets to a single destination node. However, it should be understood that the same structure also may be used in cases where data packets are sent to multiple destination nodes. The response field may be used to indicate how many request messages have been sent to different destination nodes and the pull count field may be used to store the total number of expected pulls from all destination nodes that received a request message.

FIG. 7 depicts an example of data structures used to ensure packets from a stream of ordered data packets are output in order. The data structure 700 depicted in FIG. 7 is an example of a snapshot of a data structure based on the destination node data structures that were described in FIG. 4, in operation. The outbound descriptor 702 is associated with request messages from a stream of data packets on a source node. In some example implementations, there may be an outbound descriptor associated with every stream that exists in the system. In alternate example implementations, an outbound descriptor may be associated with multiple streams. For example, an outbound descriptor may be associated with a port on a destination node, and all packets from the same source node and destined for the port may be assigned to the same outbound descriptor. Furthermore, FIG. 7 depicts an outbound descriptor on a single destination node. However, it should be understood that an outbound descriptor may exist on each destination node for which a single data packet is destined. The description below would apply to each destination node independently.

Each request message is associated with a packet descriptor 710, 720, . . . 740. The tail pointer 704 of the outbound descriptor is set to point to the packet descriptor associated with the last received request message, while the head pointer 706 is set to point to the packet descriptor that is associated with the first request message that has not yet been moved to an output queue 750.

When a new request message is received by a destination node, a packet descriptor is allocated and added to the end of the list of packet descriptors that is described by the outbound descriptor 702. The tail pointer 704 is set to point to the new packet descriptor and the next pointer 464 of the packet descriptor that was previously pointed to by the tail pointer is set to point to the newly added packet descriptor. In addition, memory space is allocated to store the data packet associated with the request message and pointers to this memory space are stored in the packet descriptor. For purposes of clarity, the memory and memory pointers are not shown. Because request messages are sent in order over a designated channel, the request messages will be received in the same order that they were sent. As such, the outbound descriptor is an ordered list of packet descriptors which are in the same order as the request messages. Since the request messages are sent in the same order as the data packets in a stream, the packet descriptors are in the same order as the data packets in the stream.

As mentioned above, in some implementations, the outbound descriptor may be associated with request messages from multiple streams that are on the same source node and destined for the same port on the destination node. In those implementations, request messages will still be sent in order, and the outbound descriptor may contain ordered request messages from multiple streams. What should be understood is that the request messages, and in turn the packet descriptors, for a given stream will be in the same order as the stream, however there may intervening packet descriptors from other streams. In other words, the packet descriptors for a stream may be in order, however the packet descriptors may not be immediately adjacent to each other.

The packet descriptor 740 may be associated with a newly received request message. The packet descriptor is added to the end of the list of packet descriptors described by outbound descriptor 702. In this example, it is assumed that the data packet will be segmented into four mPackets for transmission to the destination node, as is reflected by the segments remaining field being set to four. As the data messages containing the mPackets are received, the segments remaining count will be decremented. Transmission of the mPackets has been described in detail with respect to FIG. 5. Once the segments remaining count reaches zero, the data packet will have been completely received.

The packet descriptor 730 may be associated with a request message that has been received and all segments associated with the request message have been received. At this point, the data packet is available on the destination node. Once the head pointer 706 is set to point to the packet descriptor 730, the packet descriptor may be moved to the output queue 750. However, because the head pointer is not currently pointing at the packet descriptor 730, the packet will not be moved to the output queue, as doing so would result in the packet being placed in the output queue out of order.

The packet descriptor 720 may be associated with a request message that has been received. As indicated by the remaining segments field, there is one additional mPacket needed before the associated data packet is complete. This does not imply that the data packet consists of only one mPacket, but rather that one more mPacket is expected. As explained above, the destination node is beneficially relieved of having to keep track of the overall size of the data packet or of which particular mPackets have already been received. The destination node simply tracks how many more mPackets are expected, and once the required number is received, the data packet has been completely received.

The packet descriptor 710 may be associated with a request message that has been received and the associated data packet has been completely received. The head pointer 706 may have previously pointed to the packet descriptor 710. Once the data packet has been completely received, the packet descriptor 720 may be moved to the output queue 750. The head pointer 706 is then set to point to the next packet descriptor in the list.

The output queue 750 is a data structure used to maintain the status of data packets that are ready to be output on a port of the destination node. The packet descriptors in the output queue are in the same order as the associated packets in the stream because the packet descriptors are moved to the output queue in the same order as the request messages, which in turn are received in the same order as the data packets in the stream. The output queue may contain a head pointer 754 which points to the packet descriptor that is associated with the next data packet that should be output to the port. The output queue may also contain a tail pointer 752 which points to the last packet descriptor in the output queue and is used to add new packet descriptors to the output queue. Although only a single output queue is shown, it should be understood that there may be an output queue for each port on a destination node. The packet descriptor may be moved to the output queues that were identified in the ‘Port’ field of the request message.

The packet descriptors 760, 770, 780 may be associated with data packets that have been moved to the output queue for eventual output from a port of the destination node. When a packet descriptor 710 reaches the head of the outbound descriptor 702, the packet descriptor may be moved to the output queue. The next pointer 464 of the packet descriptor at the current tail 752 of the output queue is set to point to the packet descriptor that is being added. The tail pointer is then set to point to the newly added packet descriptor.

The destination node may retrieve the data packet associated with the packet descriptor pointed to by the head pointer 754 and output that packet on a port. The head pointer may then be advanced to the next packet descriptor in the list. The packet descriptor that was associated with the data packet that was output may then be released and become available for use when the next request message is received. As should be clear, the resulting output of data packets is in the same order as the stream of data packets.

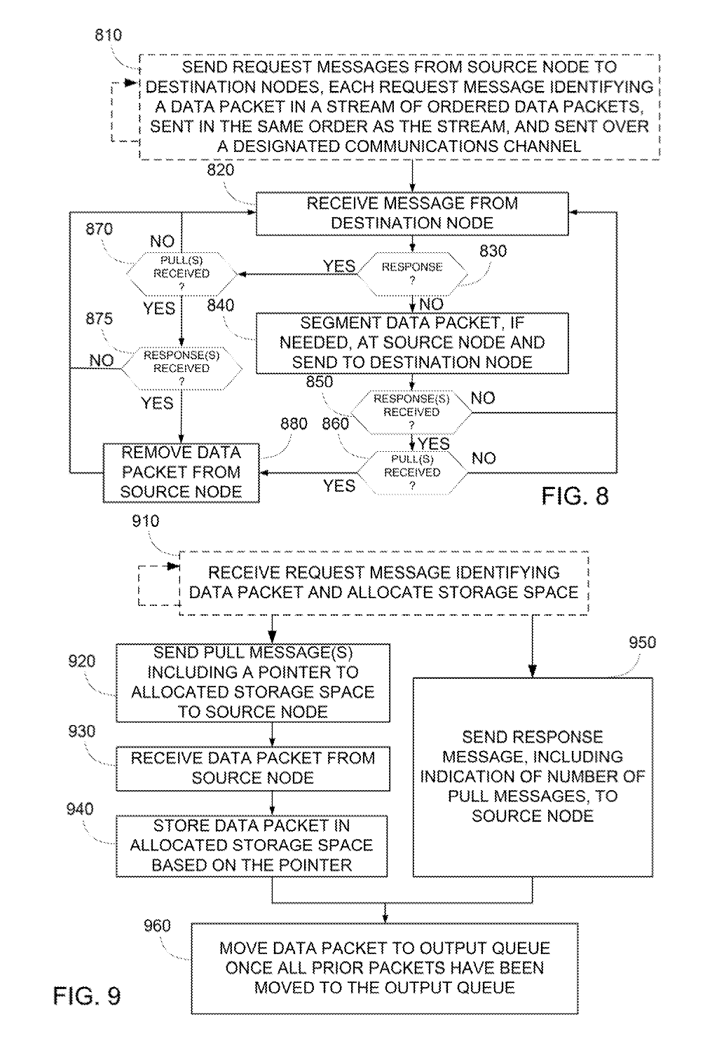

FIG. 8 depicts an example of a high level flow diagram for sending a stream of ordered request messages. The process may begin at block 810, wherein request messages are sent from a source node to destination nodes. Each request message may identify a data packet in a stream of ordered data packets. The request messages may be sent in the same order as the data packets in the stream and may be sent over a designated communications channel, thus ensuring that the request messages are received by the destination nodes in the same order as the stream of data packets. Block 810 continues indefinitely as long as new data packets are added to the stream. Block 810 generally occurs independently of the remaining blocks, as is indicated by the dashed lines and dashed self referencing pointer.

The process at the source node also continues at block 820, wherein a message is received from a destination node. As the example implementations discussed herein describe, there is no ordering imposed on any messages other than request messages. Thus, the process is able to receive any message in any order. The process then moves on to block 830 where it is determined if the message received is a response message. If the received message is a response message, the process moves on to block 870.

At block 870, the response message is examined to determine how many times the destination node will pull the data. The number of pulls is compared to the number of pull messages that have already been received. If the expected number of pulls has not yet been received, the process returns to block 820, and awaits additional messages from the destination node. If the expected number of pull messages have already been received, the process moves on to block 875 where it is determined if the expected number of response messages have been received. It should be understood that references to a pull message being received assumes that the data message in response to the pull message has been sent. In cases where request messages are sent to multiple destinations, the expected number of pull messages is complete only once all destination nodes have responded, indicating how many times the data will be pulled. If all responses have not yet been received, the process moves to block 820 to await the arrival of additional messages.

If all response messages have been received the process moves to block 880, wherein the data packet is removed from the source node. Removing the data packet may comprise transitioning the request message descriptor associated with the data packet to the inactive state. As explained above, inactive request message descriptors, and their associated data packets will eventually be removed from the source node. If at block 830 it is determined that the message is not a response message, then the message must be a pull message and the process moves on to block 840.

At block 840 it has been determined that the message received is a pull message. The data packet associated with the pull message is then sent to the destination node that sent the pull message. If needed, the data packet is segmented into an appropriate number of mPackets as required. Segmentation is not always required, as the data packet may be small enough to fit within a single mPacket, or the size of the mPacket may be chosen to be large enough to carry the largest expected size of a data packet. The process then moves on to block 850.

At block 850 it is determined if the response messages for this data packet have already been received. As has been mentioned, there is no ordering requirement on any message other that request messages. Thus, at block 850 it is determined if all the response messages have been received by examining the response field of the request message descriptor associated with this data packet. If the response field is zero, this indicates that response messages have been received for all request messages that were sent for this data packet. If all responses have not yet been received, the process returns to block 820 to await additional messages. If all the response messages have been received, the process moves on to block 860.

At block 860 the response messages have already been received and the total of the pull counts in the response messages is stored in the request message descriptor. A comparison is made to determine if the expected number of pull messages has been received. For example, a destination node may indicate that the data will be pulled twice or two separate destinations may indicate the data will be pulled once each. Until two pull messages are received, the data packet cannot be removed from the source node. At block 860 it is determined if the expected number of pull messages have been received. If not, the process returns to block 820, and awaits additional messages. If the required number of pull messages have been received the process moves to block 880, wherein the data packet is removed from the source node as described above.

FIG. 9 depicts an example of a high level flow diagram for receiving a stream of ordered request messages. The process begins at block 910 wherein request messages are received at a destination node. Each of the request messages may identify a data packet in a stream of ordered data packets. Storage space for the data packet may be allocated. Block 910 continues indefinitely, as long as new request messages are received. Block 910 generally occurs independently of the remaining blocks, as is indicated by the dashed lines and dashed self referencing pointer.

Once a request message is received, the process continues on to perform two separate operations for each request message that is received. The processes may occur in either order or may occur simultaneously. The example implementations discussed herein do not place any requirements on the order in which both of the operations occur, but rather only specify that both operations are performed.

One of the operations that is performed is retrieving the data packet from the source node. This operation may begin at block 920 wherein a pull message is sent to the source node. In some cases, the destination node may choose to pull the data multiple times, in which case multiple pull messages may be sent. Included in the pull message may be a pointer to the storage space that was allocated in block 910. At block 930, the data packet may be received from the source node in data messages. As has been described previously, a data packet may be segmented into multiple mPackets prior to being sent to the destination node. At block 930, the data packet, segmented or not, is received. At block 940, the data packet, or segments of the data packet, are stored in the allocated storage space, based on the pointer that was sent in block 920.

Although block 930 and 940 are described sequentially, it should be understood that the operations performed within those blocks may occur in parallel. For example, a first segment of a data packet may be received and stored, followed by a second segment. However, upon completion of the operations described in blocks 920-940, the complete data packet will have been received by the destination node.

The other operation is sending a response to the source node that sent the request message. The response may be sent in block 950. The destination node may send a response message to the source node. The response message may include the number of times the destination node will be pulling the data packet from the source node. The source node may use the number of times the data will be pulled to determine when all expected pull messages have been received.

Once both of the operations described above have occurred for a request message, the complete data packet is then available at the destination node. The process then moves on to block 960 wherein the data packet is moved to an output queue. As was mentioned above request messages are continuously received by the destination node. A data packet will not be moved to the output queue until data packets associated with any previous request messages in the stream of ordered request messages have been moved to the output queue. In block 960, the data packet is moved to the output queue once all prior data packets have been moved to the output queue.

The process in blocks 920-960 has been described in terms of a single request message associated with a data packet. Although not shown for purposes of clarity, blocks 920-960 may be repeated for every request message that was received in block 910.

1. A method comprising:
sending request messages from a source node to a destination node, each request message: identifying a data packet in a stream of ordered data packets; sent in the same order as the stream of ordered data packets; and sent over a communications channel designated for the stream of ordered data packets;
for each request message, receiving, from the destination node, at least one of a response message and a pull message; and
sending the data packet from the source node to the destination node based on the at least one of the response message and the pull message.

2. The method of claim 1, further comprising:
allocating storage space at the destination node for the data packet identified in each request message upon receipt of each request message;
including a pointer to the allocated storage space in the pull message; and
storing the data packet sent from the source node in the allocated storage space based on the pointer.

3. The method of claim 1, wherein the response message includes an indication of how many pull messages will be sent, further comprising:
removing, the data packet from the stream of ordered data packets at the source node once no additional response and pull messages are expected.

4. The method of claim 1, further comprising:
moving the data packet to an output queue at the destination node once all data packets in the ordered stream of data packets prior to the data packet have been moved to the output queue.

5. The method of claim 1 wherein the pull message is combined with the response message.

6. The method of claim 1 further comprising:
maintaining a source node data structure indicating a status of each data packet in the stream of ordered data packets, the status for each data packet maintained until the data packet has been sent to the destination node.

7. The method of claim 1 further comprising:
maintaining a destination node data structure indicating a status of each data packet for which the request message has been received, the status maintained until the data packet is placed into an output queue.

8. The method of claim 1 wherein sending the data packet from the source node to the destination node further comprises:
segmenting the data packet into mPackets;
allocating storage space for each of the mPackets on the destination node;
including a pointer to the storage space allocated for the mPackets, in the pull message;
sending the mPackets from the source node to the destination node; and
storing the mPackets in the allocated storage space based on the pointer, wherein the data packet is received by the destination node once all of the mPackets are received.

9. An apparatus comprising:
a destination node having an output queue;
a switch fabric providing communications channels; and
a source node coupled to the switch fabric to send request messages to the to the destination node through a designated channel of the communications channels of the switch fabric, each request message identifying a data packet, and the order of the request messages identifying the order in which the data packet identified in the request message is placed in the output queue.

10. The apparatus of claim 9 wherein the source node sends the data packet identified in each request message over any channel of the communications channels.

11. The apparatus of claim 9 wherein the destination node sends a pull message for the data packet identified in each request message at any time after receiving the request message and over any channel of the communications channels.

12. The apparatus of claim 9 wherein the destination node receives the data packets identified in each request message in any order and over any channel of the communications channels and stores the data packets in the output queue in the order of the request messages.

13. The apparatus of claim 9 wherein the source node further segments data packets into mPackets and sends each mPacket to the destination node over any of the communications channels and the destination node further receives the mPackets over any of the communications channels, wherein the data packet is received once all mPackets are received.

14. A device comprising:
a request module to generate and send ordered request messages over a designated communications channel, wherein the designated communications channel provides for in order delivery of the request messages, wherein the request messages for a stream of data packets are all sent over the same designated communications channel;
a response module to send response messages including the number of times a data packet will be pulled; and
a data module to transmit the data packet.

15. The device of claim 14 wherein the data module further segments the data packet.

16. The device of claim 15 wherein the device is an application specific integrated circuit.
